(19) United States
(12) Patent Application Publication
(10) Pub. No.: US 2008/0182938 A1
(43) Pub. Date: Jul. 31, 2008

(54) TOUGHENED MONOFILAMENTS

(76) Inventors: Heping Zhang, Summerville, SC (US); Craig Valentine, Summerville, SC (US)

Correspondence Address: TAYLOR & AUST, P.C., P.O. Box 560, 142. S Main Street, Avilla, IN, 46710, US

(21) Appl. No.: 11/627,082

(22) Filed: Jan. 25, 2007

(51) Int. Cl. C08L 77/00

(52) U.S. Cl. 525/66; 264/178 R

(57) ABSTRACT

A method of forming a monofilament or a technical fiber for use in a press felt of a papermaking machine including the steps of selecting polyamide 66, selecting polyamide 6/66, blending and forming a monofilaments. An amount of polyamide selected by weight of approximately 60-95% of a total weight. An amount of polyamide 6/66 copolymer is selected by weight in an amount of approximately 5% to 40% of the total weight. The polyamide 66 and polyamide 6/66 copolymer are blended, thereby defining a blended material. The monofilament or technical fiber is formed from the blended material.

### BACKGROUND OF THE INVENTION

1. Field of the Invention

The present invention relates to monofilaments and the method of forming them, and, more particularly to toughened monofilaments for use in press felts in a press section of a papermaking machine.

2. Description of the Related Art

Paper is conventionally manufactured by conveying a paper furnish usually including an initial slurry of cellulosic fibers onto a forming fabric or between two forming fabrics in a forming section of a papermaking machine. The nascent sheet is then passed through a pressing section and ultimately through a drying section of the papermaking machine. In the case of standard tissue paper machines, the paper web is transferred from the press fabric to a Yankee dryer cylinder and it is then creped.

Paper machine clothing is employed to carry the paper web through these various stages of the papermaking machine. In the forming section the fibrous furnish is wet-laid onto a moving forming wire and water is drained from it by way of suction boxes and foils. The paper web is then transferred to a press fabric that conveys it through the pressing section, where it usually passes through a series of pressure nips formed by rotating cylindrical press rolls. Water is squeezed from the paper web and into the press fabric as the web and fabric pass through the nip together. In the final stage, the paper web is transferred either to a Yankee dryer, in the case of tissue paper, or to a set of dryer cylinders upon which, aided by a clamping action of the dryer fabric, the majority of the remaining water is removed.

Press fabrics generally include a batt of fibers needled to a base fabric. Although the fabrics may be woven endlessly, this is not necessarily the case. Usually loops are provided at the free ends of the fabric and the interdigitated loops are connected by way of a pintel wire to form an endless structure. The base fabrics tend to be woven from monofilaments.

Monofilaments and technical fibers are typically produced by a melt extrusion process, followed by a drawing process in a solid state to achieve the desired polymer structure, particularly orientation in morphology. They differ from textile fibers and from injection molded parts in the solid state uni-axial drawing process, and the very high draw ratios needed to achieve the desired strength and toughness to suit the technical fabric application.

Technical fibers are highly oriented polymeric fibers that are used as load bearing, structural elements in engineering applications, such as industrial belts and fabrics. The tensile failure behavior of candidate materials for use in a press fabric is often studied because axial strength and stiffness are usually optimized by the polymer formulation and the processing method. In use the deformation of a typical single fiber, or monofilament, is complicated and sometimes bending deformation predominates in certain technical fabric applications.

Short-term strength data of a monofilament is derived from uni-axial testing as detailed in American Society for Testing and Materials (ASTM) D2256-97. The following tests are used to determine strength:

1. For bending strength, a loop test is conventionally used to specify a monofilament performance (see Morton, W. E., and Hearle, J. W. S., Physical Properties of Textile Fibres, the Textile Institute, Manchester 2^{nd} Edition 1975, p 410). When a monofilament is loaded in the loop measurement, it will break more easily in the bent state than when it is straight. This is primarily due to the initiation of breakage by the high extension of the outside layers.

2. Loop tenacity is a strength of a compound strand formed when one strand of yarn is looped through another strand then broken. It is the breaking load in grams divided by the measured yarn denier.

3. Loop elongation is the maximum extension of the looped yarn at maximum load, expressed as a percentage of the original gauge length.

4. Loop toughness is the actual work per unit mass (denier) required to rupture the looped strands of a yarn. Loop toughness is also called specific work of rupture as it measures the ability of the material to withstand sudden shocks in the bent or loop state.

Polyamide 66 having a nomenclature of Poly[imino(1,6-dioxo-1,6-hexanediyl)imino-1,6-haxanediyl], herein referred to as PA66, is generally regarded as a tough material for making technical fibers and monofilaments. A PA66 monofilament has good elongate and high toughness, as demonstrated by the tensile test of ASTM D2256-97. The failure mode of such monofilaments is typically in ductile fashion. PA66 monofilaments have found wide application in technical fabrics, such as load bearing materials. The combination of properties exhibited by PA66 monofilaments make them particularly suitable for use in paper machine clothing for the press section of the paper machine.

However, under loop test, the failure mode of PA66 monofilaments is typically the brittle mode. The looped stress-strain curve is very nearly linear as illustrated in FIG. 1. Careful examination of the failure process reveals that such brittle failure of PA66 monofilaments initiates from crack-like defects. These defects are indicators of impending failure for technical fabrics and service. They impair resistance to transverse impact force, a force that a press felt made of the monofilaments will experience as it is manufactured during the severe needle punching process. The crack-like defects are stress concentration points. Under bending moments, they grow and the monofilaments fail.

A fabric used in the press section of a paper machine may be constructed such that it has a seam formed from loops of the machine direction monofilaments. During service, these loops are under constant tension and bending. A brittle failure of the loops will ensure a shorter service life for the fabric.

What is needed in the art of papermaking machinery is a press belt made of long life monofilaments.

### SUMMARY OF THE INVENTION

The present invention provides a toughened monofilament and method of making a toughened monofilament for use in a press belt of a papermaking machine.

The invention in one form is directed to a method of forming a monofilament or a technical fiber for use in a press felt of a papermaking machine including the steps of selecting polyamide 66, selecting polyamide 6/66, blending and forming monofilaments. An amount of polyamide 66 is selected by weight of approximately 60-95% of a total weight. An amount of polyamide 6/66 copolymer is selected by weight in an amount of approximately 5% to 40% of the total weight. The polyamide 66 and polyamide 6/66 copolymer are blended, thereby defining a blended material. The monofilament or technical fiber is formed from the blended material.

An advantage of the present invention is that the produced monofilament or technical fiber is toughened to withstand weaving applications that cause the filament to be looped and bent.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 illustrates a loop stress-strain curve; and

FIG. 2 is a schematical illustration of the process to produce one embodiment of the toughened fibers of the present invention.

Corresponding reference characters indicate corresponding parts throughout the several views. The exemplification set out herein illustrates one embodiment of the invention and such exemplification is not to be construed as limiting the scope of the invention in any manner.

### DETAILED DESCRIPTION OF THE INVENTION

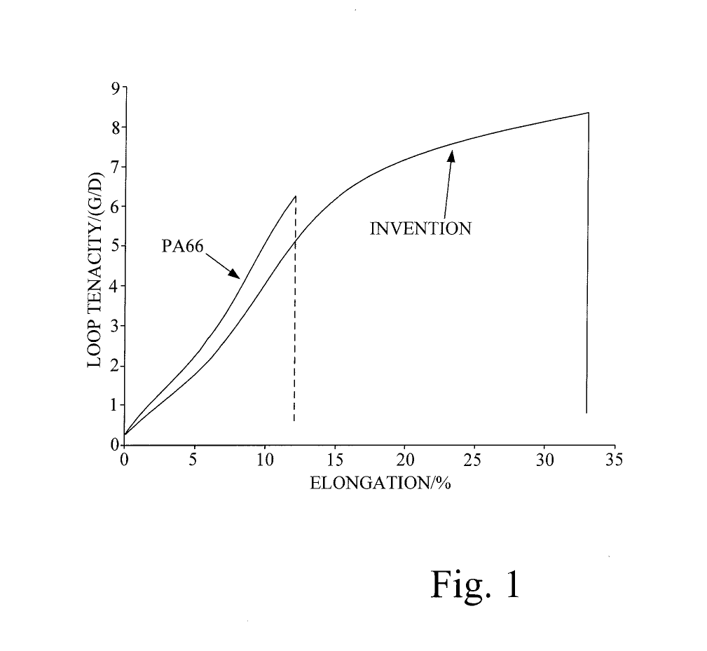

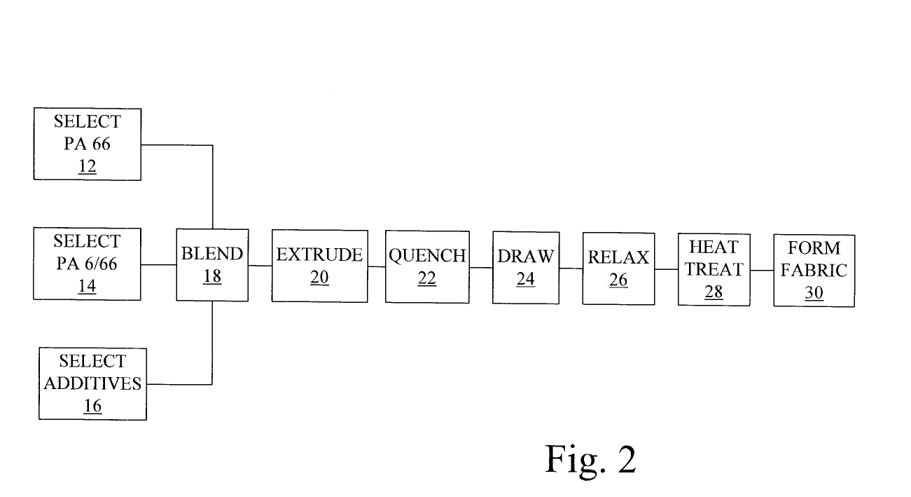

Referring now to the drawings, and more particularly to FIGS. 1 and 2, there is shown a method 10 for the production of toughened fibers of the present invention.

PA66 molded items have long been regarded as too notch-sensitive at low temperature or during high-speed impact having little resistance to crack propagation. Toughening of PA66 has been explored extensively. Appropriate incorporation of a disbursed elastomer phase has been found to be very effective for producing extremely tough nylons. Examples of such work is included in U.S. Pat. Nos. 4,174,358; 4,346,194; and 4,478,978. The elastomer inclusion for PA66 modification was not found to be applicable in technical fiber and monofilament processing. This is because the PA66 phase and elastomer phase have a tendency to separate during the solid-state uni-axial drawing process.

EP-A0-230228 discloses the production of monofilaments from the mixture of PA66 and PA6 for spiral wires. It was found however that the total portion of PA6 must not exceed 15% by weight, or a melt process instability would occur. The improvement in loop toughness from such compositions was not disclosed but found to be very limited. U.S. Pat. No. 6,238,608 discloses the using of a higher portion of PA6 , up to 25% by weight, in PA66 to make vacuole-free large diameter (0.8-1.5 mm in diameter) monofilament.

The present invention provides a polyamide formation formulation, which gives rise to technical fibers and monofilaments that not only retains the primary properties of known PA66 products, such as high melting temperature of greater than 250° C., high tensile modulus, low thermal shrinkage, high abrasion resistance and low moisture absorption, but which also give rise to technical fibers and monofilaments, which posses significantly improved loop toughness compared to those known.

According to one embodiment of the present invention, there is provided a blend of polymeric material for use in the manufacture of a monofilament or technical fiber from a blend including from 60-95% by weight of PA66 and from 5% to 40% by weight of polyamide 6/66 copolymer (hereinafter PA6/66). The blend may also include further additives in the amount of 0 to 5% by weight. The additives may include processing aids, stabilizers and performance augmenters. Examples of such materials include hindered phenolic anti-oxidants, fatty acid amides, metal salts of fatty acids and/or optical brighteners, etc.

In another embodiment of the present invention there is formed a monofilament or technical fiber from 60 to 95% by weight of PA66 and from 5 to 40% by weight of PA6/66.

The monofilaments and technical fibers of the present invention generally exhibit a number of superior technical qualities such as damage resistance, abrasion resistance and surface scratch resistance. Specific properties and monofilaments in technical fibers produced in accordance with the present invention include:
1. Loop tenacity being at least 6 g/d.
2. Loop toughness being at least 0.8 g/d.
3. Loop failure mode being ductile.
4. A broad single melt peak at greater than 250° C. and a single cooling crystallization peak measured by a differential scanning calorimeter (DSC).
5. From the DSC analysis a high crystallinity is measured from the melt area of at least 40 joules/gram.
6. Tensile strength being at least 4 g/d.
7. Tensile elongate at break being at least 30%.
8. Tensile modulus being at least 30 g/d at dry and at least 10 g/d when fully saturated by water.
9. Number of abrasion cycles until break in a flexing abrasion test being at least 70,000 for a monofilament sample of a diameter of 0.38 mm measured along a 500 gram load.

Another embodiment of the present invention includes the formulation of 60% to 95% by weight of PA66 and 5% to 40% by weight of PA6/66. The blended material is melt blended at a temperature in the range of from about 260° C. to 300° C. The material is extruded and quenched in a water bath having a temperature below 50° C. The quenched extruded material is drawn at a temperature of at least 70° C. at a draw ratio greater than 3.0. The fiber is relaxed and heat-treated, with the relax ratio being in the range of from 0.85 to 0.99 and the temperature is held in a range from 100° C. to 250° C.

The PA66 suitable for use in this invention is more accurately referred to as polyhexamethylene adipamide. The registration number of PA66 is 32131-17-2. A suitable PA66 is prepared from the polymerization of hexamethylene diamine in adipic acid or the salt derived thereof. By way of example, a continuous process for the production of this polymer is described in U.S. Pat. No. 3,948,862.

A desirable relative viscosity of PA66 is in the range of 50 to 250 as determined according to ASTM D789, and is preferably between 100 to 150.

The polyamide copolymer, PA6/66 is exemplified, by but not limited to, that prepared from the polymerization of hexamethylene diamine, adipic acid and caprolactam, or salts thereof. Such copolymers are commonly referred to as polyamide 6/66 or polyamide 66/6 depending upon the ratio of polyhexamethylene adipamide and polycaprolactam units in the copolymer. If the copolymer contains a greater proportion of polyamide 66 units it is described as polyamide 66/6, and conversely if it contains a greater proportion of polyamide 6 units it is referred to as polyamide 6/66. The polyamide copolymer preferred in this invention may include any possible ratio of PA6 to PA66 units, but is more preferably of the type that contains more PA6 units than PA66 units, hence the reference above to PA6/66. Most preferably the ratio has been found to be that of 85 to 15 PA6 to PA66.

The polycaprolatam, as described herein, is more commonly referred to as polyamide 6, or PA6 having a registration number of 25038-54-4. The relative viscosity of suitable polyamide copolymers is in the range of 50 to 250 and preferably in the range of 130 to 180 as determined by ASTM D9789.

Additives that may be incorporated to improve performance include, but are not limited to, lubricants such as metal stearates or fatty acid amides, and antioxidants of the hindered phenolic, phosphate or copper halide type.

The term monofilament as used herein refers to a single filament of any conceivable shape that has a denier greater than 15. The monofilaments described are melt spun, which initially involves melting and conveying the composition through an extruder, the melting temperature being maintained at 280° C. to 290° C. The molten polymer is then extruded through a die that forms the shape of the filament with the aid of a gear pump.

The formed extrudate must then be quenched in a suitable medium, typically water, before being taken up by way of a godet or roll stand. The temperature of the quenching medium is held between 60° C. and 120° C. Depending upon the desired size and output of the process, the take-up roll speed is maintained at between 2 and 100 m/min. The monofilaments are then drawn or oriented through a series of godets or roll stands such that the total draw ratio achieved is between 2 to 1 and 7 to 1. More preferably this ratio is between 3 to 1 and 5 to 1. The drawing temperature is kept between 60° C. and 220° C. and subsequently, the monofilaments are heat treated or relaxed to a ratio of between 0.7 to 1 and 1 to 1, at a temperature no greater than the melting point of the composition.

The monofilaments thus formed are subjected to various mechanical and thermal tests. The physical properties were determined according to ASTM D2256-97 and thermal shrinkage was established according to ASTM D204 with a temperature of the test adjusted to 176.7° C. (350° F.). The loop tenacity, elongation at loop failure and toughness were measured using a modification of ASTM D2256-97, where the single filament was replaced with two monofilaments looped through each other and clamped into the jaws of an Instron Tensile Tester. A further enhancement of the loop test was developed where one of the loops is replaced with a steel wire loop. The gauge length is reduced to five inches to accommodate the reduction in the extension of the steel. The reduced deformation of the steel wire minimizes the inherent variations of this type of test.

Thermal analysis of the monofilaments was performed using a Perkin Elmer DSC 7. The melting point was determined by ramping the temperature from 30° C. to 280° C. at a rate of 20° C./min. The sample was then held at 280° C. for three minutes before being cooled back to 30° C. at the rate of 20° C./min, in order to determine the crystallization temperature on cooling. The sample weight was maintained at approximately 10 milligrams for each test. The presence of a single melting peak on heating in a single crystallization peak on cooling was used as an indicator of the compatibility of the composition as this would suggest that the PA66 and the PA6/66 co-crystallize during production of the monofilament sample. In order to explain the invention more fully, specific examples described herein, by way of example only, and are not a limitation of the invention. FIG. 1 is a stress-strain curve of the loop breakage of a first control monofilament made of PA66 and a second monofilament made in accordance with the present invention.

Now additionally refereeing to FIG. 2, in these examples the ingredients are selected at steps 12, 14 and 16, are blended and the mixture is melt processed at step 18 in a single screw extruder with a spin pump attached for accurate throughput control. The barrel temperature was held to between 230° C. and 300° C. depending upon the polymer type at extrusion step 20. The resulting strands from the spinning head were quenched in water at step 22 with accurate temperature control. The strands were separated and dried to remove surface water and were passed through a set of three ovens for drawing, relaxing and heat treatment of steps 24, 26 and 28.

The finished monofilament is wound on spools for testing or for forming of a fabric at step 30. The finished monofilament was subject to immediate measurements for tensile properties, loop break and thermal shrinkage. The remaining samples were conditioned at a temperature of 23° C. and 80% humidity for one week before being retested as conditioned samples.

### EXAMPLE 1 AND CONTROL 1

Two PA66 polymers are used in this example having relative viscosities (RV) of 120 and 230, respectively. The RV is a measure of polymer molecular weight (MW). The other polymer is used in this comparative study had similar RV's except those specified as high MW.

The polymer used in this example was dried in a dehumidifying dryer at 80° C. for eight hours before extrusion. A 25 mm single screw extruder with a mixing head was used for monofilament extrusion. Extrudates coming from the extruder were quenched in a water bath at 26° C., taken up and drawn in two steps for a total draw ratio of 3.57:1, and then relaxed in a hot air oven at a relax ratio of 0.95. The monofilament had a diameter of 0.4 mm. Table 1 compares the intrinsic properties of various polyamide monofilaments produced using similar processing conditions.

TABLE 1

| | Comparative Study 1 | | | | | | | |
|---|---|---|---|---|---|---|---|---|
| | PA610 | PA610 | | PA6 | | | Control 1 | |
| | Low | High | | High | | | PA66- | PA66- |
| | MW | MW | PA612 | MW | PA66/6 | PA6/66 | RV120 | RV230 |
| Melting Temperature | 220 | 220 | 220 | 220 | 220 | 220 | 260 | 260 |
| (DSC Peak Position)/ | | | | | | | | |
| C. | | | | | | | | |
| Loop toughness/(g/d) | .3 | 0.6 | 0.2 | 0.6 | 0.5 | 1.7 | 0.2 | 0.4 |
| Tensile tenacity/(g/d) | 3.5 | 4.1 | 4.9 | 4.2 | 4.5 | 3.7 | 3.7 | 4 |
| Elongate at break/% | 33 | 50 | 31 | 36 | 35 | 75 | 30 | 40 |
| Thermal shrinkage at | 11 | 8 | 8 | 9 | 9 | 12 | 8 | 9 |
| 177° C./% | | | | | | | | |

From the foregoing it can be seen that the monofilament produced from the copolymer of PA6/66 had a very high loop toughness. However, this polymer also has a very low melting point and very high thermal shrinkage at high temperature. These properties are not desirable for press felt manufacturing. It is also seen that the use of a high molecular weight PA66 cannot effectively improve the loop toughness.

### EXAMPLE 2

This example illustrates the compatibility between PA66 as the primary component and PA6/66 as the secondary component. The polymers were tumble blended and melt extruded using the 25 mm single screw extruder. All the samples are in monofilament form with a diameter of 0.4 mm. The melt extrusion conditions and post processing, which includes quenching, drawing and heat treatment, were the same for this group of samples.

DSC measurement was used to specify the melt temperature and crystallization temperature at cooling. The DSC sample weight was approximately 10 milligrams. Heating and cooling rates were 20° C. per minute. The sample was kept at 280° C. for three minutes before cooling.

The blend of PA66 with PA6/66 or PA66/6 showed a single broad melt point, suggesting a co-crystallization occurred during monofilament manufacturing. Such compatibility was further proven in the measurement of a single crystallization peak during the cooling process of the sample after it was melted. Though the compatibility was observed for both PA66-PA6/66 and PA66-PA66/6, the improvement in loop toughness for this sample was different. There is little loop toughness increase in the samples with PA66/6 but a significant increase with the ones made of PA66 with PA6/66.

Subsequent studies of the morphology of this group of samples reveal that PA6/66, after the given processing conditions, had a very fine and uniformly distributed spherulitic crystals in the monofilaments. The spherulitic crystals in the control sample were at least ten times bigger and densely distributed. It is this morphological change in the PA66-PA6/66, which is believed to increase the loop toughness of the monofilament samples.

TABLE 2

| Sample | | | | | | Control | | |
|---|---|---|---|---|---|---|---|---|
| Sample ID | 1 | 2 | 3 | 4 | 5 | 7 | 8 | 1 |
| PA66 wt % | 90 | 80 | 70 | 60 | 0 | 70 | | 100 |
| PA6/66 wt % | 10 | 20 | 30 | 40 | 100 | 0 | | 0 |
| PA66/6 wt % | | | | | | 30 | 30 | |
| PA66, High | | | | | | | 70 | |
| MW | | | | | | | | |
| Melt | 263 | 264 | 264 | 248 | 201 | 260 | 258 | 265 |
| temperature | | | | | | | | |
| (Dsc melt | | | | | | | | |
| peak)/c | | | | | | | | |
| Crystallization | 219 | 217 | 213 | 213 | 161 | 218 | 218 | 229 |
| temperature | | | | | | | | |
| onset at | | | | | | | | |
| cooling)/c | | | | | | | | |
| Loop | 0.8 | 0.8 | 1.2 | 1.2 | 1.8 | 0.3 | 0.3 | 0.3 |
| toughness/(g/d) | | | | | | | | |
| Tensile | 4.3 | 4.3 | 4.5 | 4.4 | 6 | 4.0 | 3.8 | 4.4 |
| tenacity/(g/d) | | | | | | | | |
| Elongate at | 35 | 35 | 50 | 50 | 40 | 40 | 40 | 30 |
| break/% | | | | | | | | |
| Thermal | 8 | 8 | 8 | 8 | 15 | 6 | 8 | 8 |
| shrinkage at | | | | | | | | |
| 177° C./% | | | | | | | | |

### EXAMPLE 3

This example illustrates the effect of the post processing, which includes the rate of quenching the melt extrudate, drawing and heat treatment, and relaxation on the properties of a highly oriented monofilament. The composition of the comparative samples was fixed at 30% by weight of PA6/66 and 70% by weight of PA66. The polymers were tumble blended, dried in a dehumidifying dryer at 80° C. for at least eight hours and melt extruded using the 25 mm single screw extruder. The monofilament produced was approximately 0.4 mm in diameter.

TABLE 3

| | Comparative Sample | | | | | | Controls | |
|---|---|---|---|---|---|---|---|---|
| | 1 | 2 | 3 | 4 | 5 | 6 | 1 | 2 |
| PROCESSING | | | | | | | | |
| 1^{st} roll speed/rpm | 20 | 20 | 20 | 20 | 20 | 20 | 20 | 20 |
| 1^{st} oven | 225 | 225 | 225 | 225 | 225 | 225 | 225 | 225 |
| temperature/F. | | | | | | | | |
| 2^{nd} oven | 350 | 350 | 350 | 350 | 350 | 350 | 350 | 350 |
| temperature/F. | | | | | | | | |
| 3^{rd} and 4^{th} oven | 425 | 425 | 425 | 425 | 425 | 425 | 425 | 425 |
| temperature/F. | | | | | | | | |
| 1^{st} draw ration | 3.5 | 3.5 | 3.5 | 3.5 | 3.5 | 3.5 | 3.5 | 3.5 |
| 2^{nd} draw ratio | 1.02 | 1.3 | 1.5 | 1.3 | 1.5 | 1.5 | 1.5 | 1.3 |
| 3^{rd} relax ratio | 0.95 | 0.84 | 0.823 | 0.95 | 0.95 | 0.95 | 0.823 | 0.95 |
| Total draw ratio | 3.3915 | 3.822 | 4.32075 | 4.3225 | 4.9875 | 4.9875 | 4.32075 | 4.3225 |
| PROPERTIES | | | | | | | | |
| Denier | 1300 | 1380 | 1365 | 1410 | 1430 | 1418 | 1341 | 1429 |
| Tensile | 4 | 5.2 | 6.7 | 5.8 | 7 | 7.2 | 6.8 | 5.8 |
| Tenacity/(g/p) | | | | | | | | |
| Tensile elongation | 33 | 30 | 25 | 20 | 14 | 12 | 20 | 18 |
| at break/% | | | | | | | | |
| Tensile | 48 | 49 | 50 | 50 | 54 | 54 | 55 | 56 |
| Modulus/(g/d) | | | | | | | | |
| Thermal shrinkage | 8 | 7 | 8.5 | 13.4 | 15 | 17.3 | 5.5 | 9 |
| at 177° C. | | | | | | | | |
| Loop tenacity/(g/d) | 6.7 | 7.8 | 6.8 | 5.6 | 4.2 | 3.4 | 5 | 6.3 |
| Loop elongation at | 22 | 28 | 14 | 14 | 10 | 14 | 14 | 6 |
| break/% | | | | | | | | |
| Loop toughness | 0.5 | 1.2 | 0.4 | 0.2 | 0.15 | 0.1 | 0.15 | 0.1 |

### EXAMPLE 4

In this example, the effect of the diameter of the polymer monofilament on the loop toughness is illustrated. Two sets of data are included in the example, one is the data marked as ‘conditioned’. The samples used in this set of data are those conditioned at room temperature (23° C.) and a humidity of 85%. The other set of data, marked as ‘shrunk’ were shrunk at 177° C. (350° F.) for three minutes before the measurement. The shrunk sample would better simulate the true state as used in the finished technical fabrics, as the fabrics would be heat set for fabric dimensional stability.

All the samples in the examples are in monofilament form and were melt processed in a 68 mm single screw extruder, quenched in a cold water bath and drawn and heat set as described in the previous examples. The example samples are blends of PA66 with PA6/66 and the controls are made of PA66 only. The two sets of data, conditioned and shrunk, are presented in Table 4.

TABLE 4

| | | Example 1 | Control 1 | Example 2 | Control 2 | Example 3 | Control 3 | Example 4 | Control 4 |
|---|---|---|---|---|---|---|---|---|---|
| | Polymer | PA66- | PA66 | PA66- | PA66 | PA66- | PA66 | PA66- | PA66 |
| | system | PA6/66 | | PA6/66 | | PA6/66 | | PA6/66 | |
| | Diameter/mm | 0.25 | 0.25 | 3 × 0.25, | 3 × 0.25, | 0.406 | 0.406 | 0.432 | 0.432 |
| | | | | 3-ply | 3-ply | | | | |
| | | | | twisted | twisted | | | | |
| Conditioned | Loop | 9(1) | 7.4(1.8) | 6.4(0.1) | 4.8(1.3) | 7.2 | 5.8 | 8.5(0.7) | 6.1(0.5) |
| sample | tenacity/(g/d) | | | | | | | | |
| | Loop | 28(8) | 11(4) | 23(3) | 17(5) | 20 | 7 | 42(6) | 16(2) |
| | elongation/% | | | | | | | | |
| | Loop | 1.6(0.7) | 0.5(.4) | 0.8(.1) | 0.4(.1) | 1.1 | 0.3 | 2.4(0.5 | 0.5(0.1) |
| | toughness | | | | | | | | |
| Thermal | Loop | 8.1(0.9) | 6.8(1.0) | 6.3(0.1) | 6.1(0.4) | 7.1 | 5.5 | 7.4(0.8) | 6.0(0.3) |
| shrunk | tenacity/(g/d) | | | | | | | | |
| sample | Loop | 27(4) | 17(3) | 35(4) | 25(4) | 18 | 7 | 34(7) | 20(1) |
| | elongation/% | | | | | | | | |
| | Loop | 1.2(0.3) | 0.6(0.2) | 1.1(0.2) | 0.7(0.4) | 0.8 | 0.2 | 1.5(0.5) | 0.7(0.1) |
| | toughness | | | | | | | | |

In Table 4, data in brackets are the measurement range. The modified PA66, through the addition of PA6/66 clearly demonstrates the advantage of a much tougher loop over the pure PA66 products.

### EXAMPLE 5

In this example the loop toughness data from two fabrics are presented. The fabrics are termed seamed press felts and are used in a paper machine clothing application for the papermaking industry. The monofilament loops are formed in the end of the fabric by way of a weaving process. The loops from both ends are joined together by way of pentel wires to form a complete endless fabric. The loop yarns are subjected to constant loop flexing and loop tension, and therefore become the weakest link for the whole fabric.

Two fabrics were made in the same weaving, seaming and post processing steps. They were put on the same paper machine position in a paper mill. After the predetermined time of sixty days, they were taken off the paper machine. The retained seam loop strength was measured using the wire loop measurement method detailed previously.

TABLE 5

| | | | | Loop yarn | |
|---|---|---|---|---|---|
| | | | Loop yarn | remaining loop | Loop yarn |
| | | Loop yarn | remaining loop | elongation at | remaining loop |
| | Polymer | diameter/mm | tenacity/(g/d) | break/% | toughness |
| Example 1, used | Material From | 0.406 | 5.4(0.7) | 12(4) | 0.06(0.03) |
| fabric, seam | Invention | | | | |
| loop | | | | | |
| Control 1, Used | PA66 as control | 0.406 | 4.0(0.8) | 10(5) | 0.03(0.01) |
| fabric, seam | | | | | |
| loop | | | | | |

With reference to FIG. 1 it can be seen that the relationship between loop elongation and loop tenacity is substantially proportional with respect to PA66 and that the fibers made from PA66 only break as a result of brittle failure, while the fibers made in accordance with the present invention break as a result of ductile failure.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method of forming one of a monofilament and a technical fiber for use in a press felt of a papermaking machine, comprising the steps of:
selecting by weight an amount of polyamide 66 from approximately 60% to 95% of a total weight;
selecting by weight an amount of polyamide 6/66 copolymer from approximately 5% to 40% of said total weight;
blending said polyamide 66 and said polyamide 6/66 copolymer thereby defining a blended material; and
forming at least one of the monofilament and the technical fiber from said blended material.

2. The method of claim 1, further comprising the step of selecting by weight an amount of additives from approximately 0% to 5% of said total weight, said blending step including the blending of said additives with said polyamide 66 and said polyamide 6/66 copolymer, said additives including at least one of processing aids, stabilizers and performance augmentations.

3. The method of claim 2, wherein said additives include at least one of hindered phenolic anti-oxidants, fatty acid amides, metal salts of fatty acids and optical brighteners.

4. The method of claim 1, wherein said blending step includes the step of melt blending said polyamide 66 and said polyamide 6/66 copolymer at a temperature in the range of approximately 260° C. to 300° C.

5. The method of claim 4, further comprising the step of extruding said blended material through a die thereby defining extruded material.

6. The method of claim 5, further comprising the step of quenching said extruded material in a water bath.

7. The method of claim 6, wherein said water bath has a temperature of below 50° C.

8. The method of claim 6, further comprising the step of drawing said extruded material after said quenching step at a temperature of at least 70° C.

9. The method of claim 8, wherein said drawing step includes drawing said extruded material at a draw ratio greater than 3.0 thereby defining a drawn fiber.

10. The method of claim 9, further comprising the step of relaxing said drawn fiber at a relax ratio in the range of 0.85 and 0.99.

11. The method of claim 10, further comprising the step of heat-treating said drawn fiber at a temperature in the range of approximately 100° C. to 250° C.

12. The method of claim 1, wherein said polyamide 66 has a relative viscosity in a range of 50 to 250 as determined according to ASTM D789.

13. The method of claim 12, wherein said viscosity has a range of 100 to 150.

14. The method of claim 1, wherein said polyamide 6/66 has a relative viscosity in a range of 50 to 250 as determined according to ASTM D789.

15. The method of claim 14, wherein said viscosity has a range of 130 to 180.

16. The method of claim 5, further comprising the step of quenching said extruded material in a medium.

17. The method of claim 16, wherein said medium has a temperature of between 60° C. and 120° C.

18. The method of claim 16, further comprising moving said extruded material at a speed of between 2 and 100 m/min.

19. The method of claim 16, further comprising the step of drawing said extruded material at a total draw ratio of between 2:1 and 7:1 thereby defining a drawn monofilament.

20. The method of claim 19, wherein said total draw ratio is between 3:1 and 5:1.

21. The method of claim 19, wherein said drawing step is carried out with said drawn monofilament being at a temperature of between 60° C. and 220° C.

22. The method of claim 19, further comprising the step of one of relaxing said drawn monofilament at a relax ratio in the range of 0.7:1 and 1:1 and heat treating said drawn monofilament at a temperature no greater than the melting point of said blended material.

23. A fiber for use in a press felt of a papermaking machine, the fiber comprising:
an amount by weight of polyamide 66 of approximately 60% to 95% of a total weight; and
an amount by weight of polyamide 6/66 copolymer of approximately 5% to 40% of said total weight, said polyamide 66 and said polyamide 6/66 copolymer being blended to define a blended material, said blended material being heated and extruded to form the fiber.

24. The fiber of claim 23, further comprising an amount by weight of at least one additive from approximately 0% to 5% of said total weight, said at least one additive including at least one of processing aids, stabilizers and performance augmentations.

25. The fiber of claim 24, wherein said additives include at least one of hindered phenolic anti-oxidants, fatty acid amides, metal salts of fatty acids and optical brighteners.

26. The fiber of claim 23, wherein said polyamide 66 and said polyamide 6/66 copolymer are heated to a temperature in the range of approximately 260° C. to 300° C.

27. The fiber of claim 26, wherein the fiber is quenched in a water bath once it is extruded.

28. The fiber of claim 27, wherein the fiber is heat treated at a temperature of at least 70° C. after being quenched.

29. The fiber of claim 28, wherein the fiber is drawn at a draw ratio greater than 3.0.

30. The fiber of claim 29, wherein the fiber is relaxed at a relax ratio in the range of 0.85 and 0.99.

31. The fiber of claim 23, wherein said polyamide 66 has a relative viscosity in a range of 50 to 250 as determined according to ASTM D789.

32. The fiber of claim 31, wherein said viscosity has a range of 100 to 150.

33. The fiber of claim 23, wherein said polyamide 6/66 has a relative viscosity in a range of 50 to 250 as determined according to ASTM D789.

34. The fiber of claim 33, wherein said viscosity has a range of 130 to 180.
